(19) United States
(12) Patent Application Publication
(10) Pub. No.: US 2009/0111582 A1
(43) Pub. Date: Apr. 30, 2009

(54) Method and Apparatus for Tracking Sports Play

(75) Inventors: Francesca Schuler, Des Plaines, IL (US); Krishna Jonnalagadda, Agonquin, IL (US); Xun Luo, Cicero, IL (US); Irfan Nasir, Lake in the Hills, IL (US); Kaidi Zhao, Hoffman Estates, IL (US)

Correspondence Address: LEVEQUE INTELLECTUAL PROPERTY LAW, P.C., 221 EAST CHURCH ST., FREDERICK, MD, 21701, US

(73) Assignee: MOTOROLA, INC., Schaumburg, IL (US)

(21) Appl. No.: 11/930,369

(22) Filed: Oct. 31, 2007

(51) Int. Cl. A63F 13/06; A63B 67/00; A63F 9/24

(52) U.S. Cl. 463/42; 473/415

(57) ABSTRACT

A method and apparatus for automated play tracking sports play. A coordinating device receives first messages from player wireless sensors node carried by the players and a second message from a ball wireless sensor node carried by the ball. From these messages, the locations of the players and the ball are determined. From the relative locations of the players and the ball it is determined, which, if any, of the plurality of players possess the ball and a description of play is generated automatically. This description may be broadcast to subscribers via a network.

### BACKGROUND

Play tracking in sporting events such as tennis, soccer, American football, rugby, ice hockey and basketball, is usually performed by people who provide a verbal or written commentary of events. This commentary may be broadcast to subscribers as voice or text.

Recently, automated tracking of some events has been disclosed. For example, a radio transmitter, such as a Radio Frequency Identification (RFID) tag has been implanted in a ball and used to track the position of ball. Radio receivers (also called readers) may be placed at fixed locations around a playing area. In particular, radio receivers have been placed in a scoring area, such as a goal post, to record when the ball enters the scoring area.

Similarly, other technologies, such as the use of a magnetic ball or three-dimensional imaging, have been used to track ball positions with respect to the edges of a tennis court. These devices aid line judges.

While these approaches cover one aspect of the play, namely the position of the ball relative to the area of play, they do not provide automated play-by-play tracking of events.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a simplified diagram of a system for automated tracking of play in a sporting event in accordance with some embodiments of the invention.

FIG. 2 is a flow chart of a method for automatic generation of play tracking information in accordance with some embodiments of the invention.

FIG. 3 is a diagram showing automated generation of play descriptions in accordance with some embodiments of the invention.

FIG. 4 is a flow chart of method for a subscriber device to receive an automated play description in accordance with some embodiments of the invention.

FIG. 5 is a simplified diagram of a system for automated tracking of play in a sporting event in accordance with some embodiments of the invention.

FIG. 6 is a simplified diagram of a further system for automated tracking of play in a sporting event in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to tracking play in sporting events. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may comprise one or more conventional processors and unique stored program instructions that control the one or more processors to implement, in conjunction with certain non-processor circuits, some, most, or all of the functions associated with the tracking play in sporting events described herein. The non-processor circuits may include, but are not limited to, a radio receiver, a radio transmitter, signal drivers, clock circuits, power source circuits, and user input devices. As such, these functions may be interpreted as a method to track play in sporting events. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

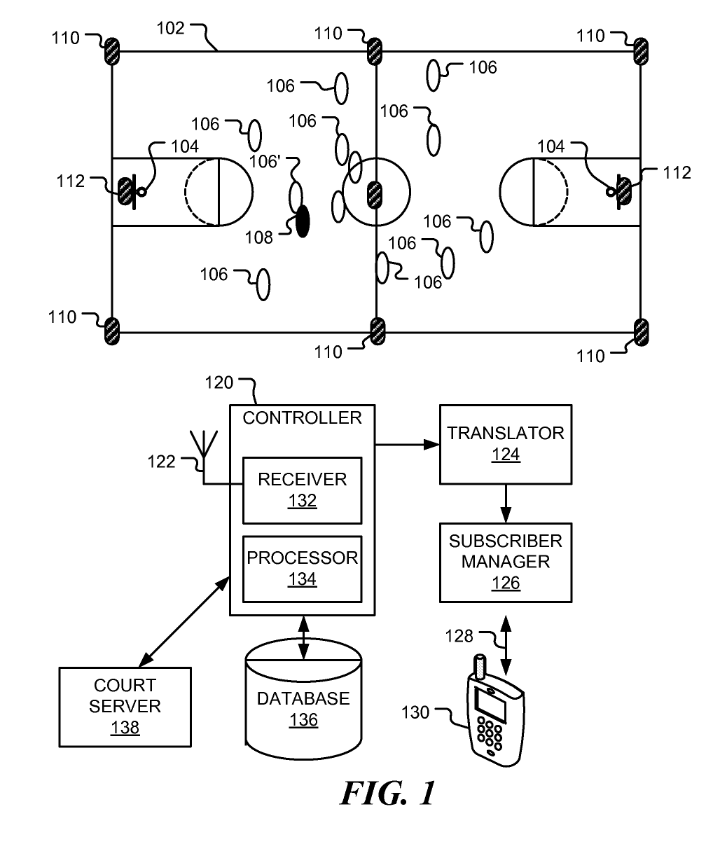

FIG. 1 is a simplified diagram of an exemplary embodiment of a system for automated tracking of play in a sporting event in accordance with some embodiments of the invention. The sport is played by a number of players within a defined playing area 102. Scoring areas 104 are also defined. In this example the sport is basketball, and the scoring area 104 is hoop. In other sports the scoring area may be a goal (e.g. soccer, hockey) or a line (American football or rugby, for example). The system includes a number of first wireless sensor nodes 106, each carried by a player, and a second wireless sensor node 108 carried by the ball. The first wireless sensor nodes 106 may be attached to a wristband, ankle-band, shoe, helmet, or belt of a player, or otherwise carried by the player. Here, the term ‘ball’ is taken to include any token that is used in the sport. For example, ice hockey uses a puck as a token. A number of fixed nodes 110 are positioned in or around the area of play 102. These may be located in the floor and/or on the ceiling, for example. The fixed nodes may be radio frequency identification (RFID) tags, or wireless network nodes that operate under WiFi (IEEE 802.11) or ZigBee (IEEE 802.15.4) protocols, for example. RFID tags receive power from and communicate with a reading device. They are very low cost and multiple tags may be used to define a mesh or gird across the playing area. In one embodiment of the invention, the first and second wireless sensors nodes are RFID tag readers that query one or more RFID tags. Each tag responds by providing its location or by providing information, such as an identifier, from which its location may be determined. The location of the players and the ball may be determined from this information. Wireless network nodes may determine their positions by exchanging messages with nodes at fixed locations. It is understood that not every player on a team may be required to carry a wireless sensor node, thought this is certainly within the scope of various embodiments.

In one embodiment, the player wireless sensor nodes and the ball wireless sensor node use a ZigBee or WiFi communication protocol. The order of play is determined from successive locations of the plurality of players and the ball. For example, if the ball moves from a location close to a first player one team to a second player of the same team, it may be assumed that the ball has been passed from the first player to the second player.

Ball possession and scoring events may be determined from the location data.

Other methods may be used to determine the locations of the players and/or the location of the ball. For example, an optical, magnetic or infrared sensor may be used to detect scoring events.

A controller 120 is used to receive messages via antenna 122 from the wireless sensor nodes 106 carried by the players and from the wireless sensor node 108 carried by the ball. The controller may be a coordinating node of a ZigBee network, for example. Information in the messages is used to determine the locations of the players and the ball. The messages may contain a description of the location, or may contain information from which the location can be determined. Once the locations of the players and the ball are known, it may be determined which, if any, of the players possess the ball information. A play description may then be generated by translator 124. The play description may include which player, if any, possesses the ball, the players' identities, scoring events, and play sequences. The controller 120 is operable to disseminate the play description via a subscriber manager 126 and wired or wireless network 128 to a subscriber device 130. The subscriber device 130 may be a mobile device such as a mobile telephone or personal digital assistant (PDA). A play description may be followed by prior history data based on plays at that court specifically for that game, prior games at that court (e.g. United Center) or another court (e.g. Madison Square Garden), or plays from a specific team member during that game or another game on the same court or a different court. For this purpose, the controller 120 may operate as a court server that can port data to a common database 136 or other networked court servers 138. This allows concurrent and historical information to be retrieved.

The subscriber manager 126 services requests from subscriber devices and sends play information to the subscriber devices. The translator 124 may be integrated with the controller 120 or with the subscriber manager 126.

The controller 120 comprises a receiver 132, coupled to antenna 122, and a processing device 134. It may be located close to the area of play. The controller 120 may be a coordinating sensor node, for example. The processing device 134 may be directly coupled with the receiver 134 or coupled via a data network.

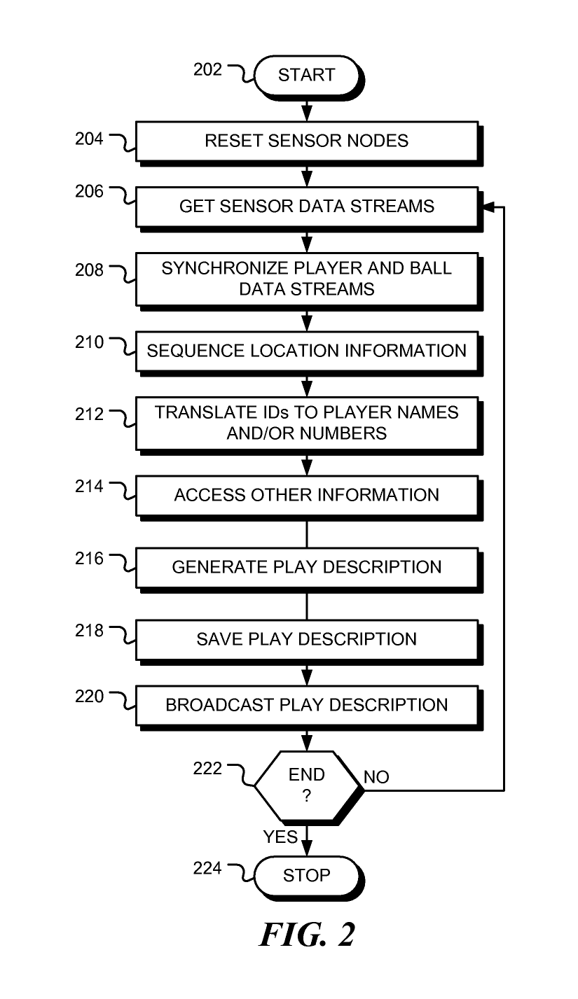

In operation, a subscriber may receive a play-by-play description of a sporting event, together with historical data, on a subscriber device 130. In one embodiment, a subscriber first downloads a description of an area of play to subscriber device 128. As play continues, the locations and identifiers of the first sensor nodes, carried by each of the players, and the location of the second sensor node, carried by the ball, are downloaded to subscriber device periodically. The subscriber device 130 may display a graphical visualization of the play, a textual description, or an audio description (generated automatically from a textual description using a text-to-speech engine). In the graphical visualization, the subscriber may assign an avatar to each identifier, so that the graphical visualization shows the area of play with avatars at the locations of the first sensor nodes and also shows the location of the ball. FIG. 2 is a flow chart of a method for automatic generation of play tracking information. Following start block 202 in FIG. 2, the player and ball sensor nodes are reset at block 204. This may occur at the start of a game or at the start of a play session within a game. At block 206, a controller receives sensor data streams from the player and ball sensor nodes. These data streams may include time stamps that enable the streams to be synchronized with one another at block 208. At block 210 the location information extracted from the data streams is sequenced. This enables ball possession to be determined, for example. At block 212 the player sensor identifiers are translated into player names and/or numbers. Optionally, at block 214, other data sources, such as a database or a networked device at another court, may be accessed to retrieve historical or other background information. At block 216 a play description is generated. The description may include the historical data. For example, a description may include the text “Chandler Passes to Curry, Curry to Davis, Davis scores a 3 pointer! This is Davis' 3^{rd} 3 pointer of this game”, which includes game statistics. As a further example, the description may include the text “Davis scores a 3 pointer. This is Davis' 15^{th} 3 pointer of the year”, which includes historical data for the player. As a still further example, the description may include the text “Davis scores a 3 pointer. Davis has scored 20% of his 3 pointers at this stadium”, which includes historical data for the stadium.

The play description may be a text description in the form of a commentary, as described above, or it may be a data description that allows a subscriber device to generate a graphical visualization of play.

At block 218, the play description may be saved in a database or transmitted to other networked devices. Finally, at block 220, the play description is broadcast to subscribers. If play has ended, as depicted by the positive branch from decision block 222, the process terminates at block 224, otherwise flow continues to block 206, where more data streams are received.

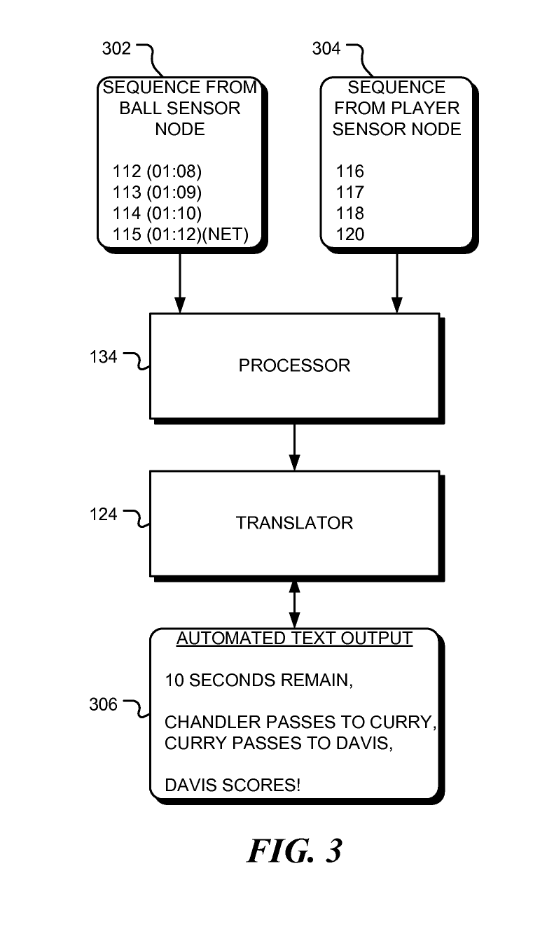

FIG. 3 is a diagram showing automated generation of play descriptions in accordance with some embodiments of the invention. Referring to FIG. 3, a message sequence 302 from the ball wireless sensor node (carried by the ball) and one or more data sequences 304 from the player wireless sensor node (carried by the players) are received by a processor 134 of a coordinating device. The message sequences may include time stamps used for synchronization of sensor nodes, and location information (such as the identifiers of nearby fixed nodes, or grid references, for example). A message sent by a player wireless sensor node may comprise an identifier of the player carrying the wireless sensor node, the location of the player in an area of play and a time stamp, the location of the player being determined by the player wireless sensor node. The location of the player may be determined relative to nodes at fixed positions, for example. The location of the ball may be determined relative to nodes at one or more fixed scoring positions, for example. The message sequences may contain a description of the location, or may contain information from which the location can be determined. The processor 134 compares the locations of the ball and the players. From this information, it may be determined which player possesses the ball, when a ball is passed from one player to the next on the same team, and when possession of the ball passed from one team to another.

In addition, it may also be determined when the ball enters a scoring area, and which player was the last player to posses the ball. Having determined this information, the translator 124 processor generates a text message 306 that provides a textual description of play events. In this example in FIG. 3, the ball is initially in close proximity to the player Chandler, then in close proximity to the player Curry, and then in close proximity to the player Davis. The ball then enters the scoring area. The message 306, containing the play description, may be transmitted over a network to a subscribing device, or may be stored in a database for later analysis or viewing.

The subscriber device may be a mobile telephone, portable computer, personal digital assistant (PDA) or other electronic device.

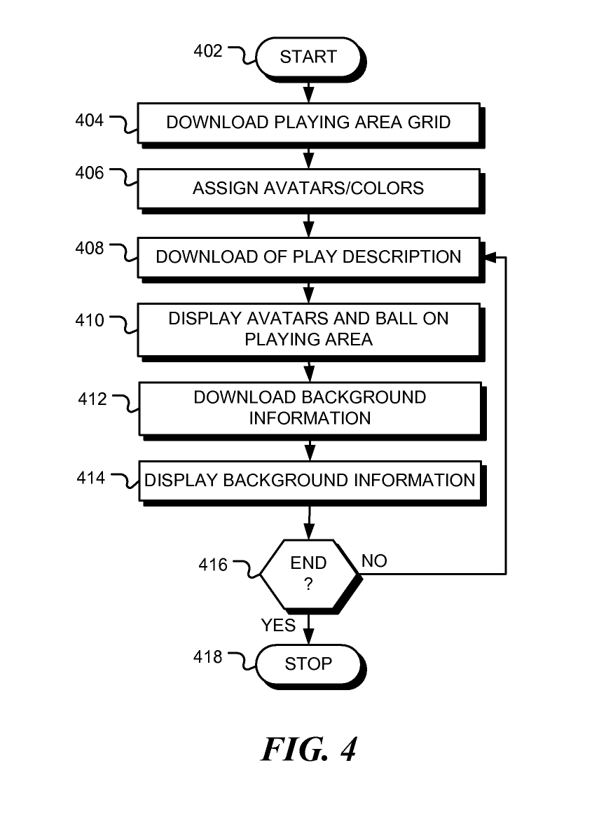

FIG. 4 is a flow chart of method for a subscriber device to receive an automated play description in accordance with some embodiments of the invention. Following start block 402, a description of the defined area of play is downloaded to the subscriber device at block 404 if a graphical visualization is to be generated. This may be in the form of grid coordinates, for example. In addition, at block 406, the subscriber may assign colors or avatars to players to be shown in the visualization. At block 408, a sequence of play descriptions is downloaded to the subscriber device. These play descriptions may be presented to the subscriber as text, audio (generated by a text-to-voice engine) and/or a graphical visualization. In the case of graphical visualization, the subscriber device, at block 410, uses player and ball location information in the downloaded play description to position avatars or other markers on a representation of the area of play.

The subscriber device may store play descriptions so that actions may be replayed. A subscriber can select to “replay” via avatars on their mobile device. They can choose the replay, based on time, score, or player, etc.

In a further embodiment, the play information is passed to another application or program. For example, the application may be a game, such as fantasy football, where a person's point score or other game related information is automatically updated dependent upon the play description.

In one embodiment, the play information includes background information, such as game and player statistics, other game scores and historical information, which is downloaded to the subscriber device at block 412. The background information may be displayed to the subscriber at block 414. At decision block 416, a check is made to determine is the play description should end. If so, as depicted by the positive branch from decision block 416, the process terminates at block 418. Otherwise, flow returns to block 408 and more play descriptions are downloaded to the subscriber device.

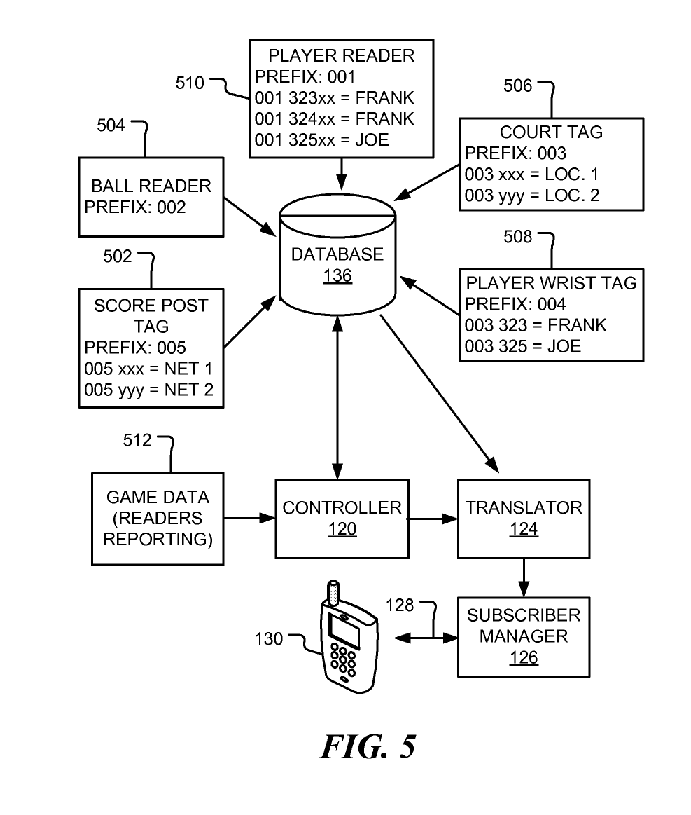

FIG. 5 is a simplified diagram of a system for automated tracking of play in a sporting event in accordance with some embodiments of the invention. In this example, RFID tags and readers are used to gather information from the area of play. Referring to FIG. 5, a database 136 stores information 502 from tags in a scoring area (on a goal post, for example), information 504 from a reader in the ball, information 506 from court tags, information 508 tags in player wrist bands, and information 510 from player readers. This information associates tag and reader identifiers with particular players or particular fixed locations. In this example, each identifier has a prefix that identifies the type of device. For example, prefix 001 is associated with player readers. The next three numbers of the identifier are associated with a particular player and, optionally, the next numbers identify particular locations on the player (such as body or limb position). The database 136 is accessed by the controller 120 and/or the translator 124 and is used to process the game data 512. The game data is generated by the player and ball readers, which read the tag information. For example a player reader in a shoe may read the identifiers of fixed tags in floor and report the tag identifiers and its own identifier. A time stamp may also be reported. The controller 120 can then access the database 136 to determine the name and location of the player. As another example, the ball reader may read the identifier of a tag in the wrist band of a player. The wrist tag identifier and the ball identifier are transmitted to the controller 120 and the database 126 is accessed to determine which player possesses the ball. This information is translated into a text message by translator 124 and passed to subscriber manager 126 for dissemination to subscribers 130. In addition, the processed data (player location and ball possession, for example) may be stored in the database 126 for later retrieval by the controller of by other devices (such as other court servers) networked to the database 136.

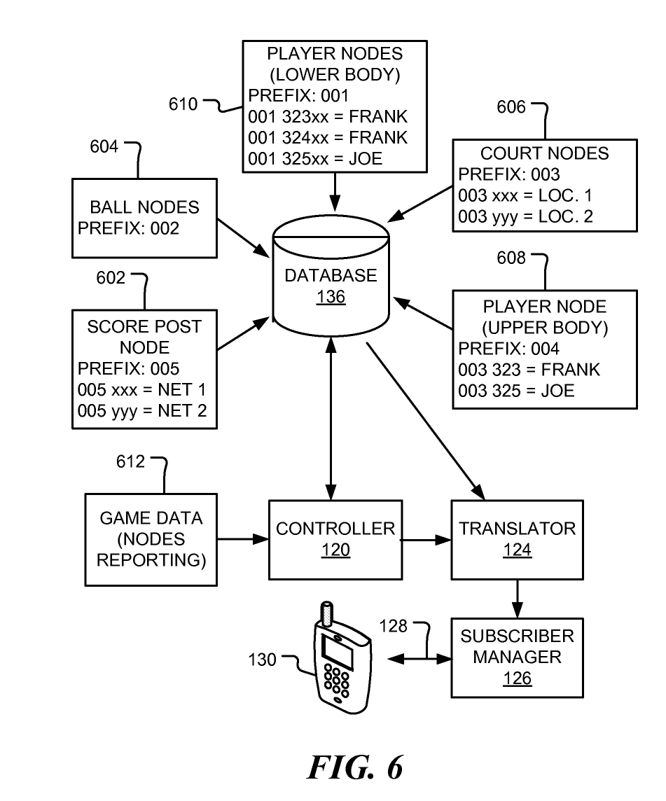

FIG. 6 is a simplified diagram of a system for automated tracking of play in a sporting event in accordance with some embodiments of the invention. In this example, wireless sensor nodes are used to gather information from the area of play. Referring to FIG. 6, a database 136 stores information 602 from nodes in a scoring area (on a goal post, for example), information 604 from a node in the ball, information 606 from fixed court nodes, information 608 player upper body nodes, and information 610 from player lower body nodes. This information associates node identifiers with particular players or particular fixed locations. The database 136 is accessed by the controller 120 and/or the translator 124 and is used to process the game data 612. The game data 612 is generated by the nodes. Player and ball nodes, which are mobile nodes, may determine their location by exchanging messages with fixed nodes (court nodes and scoring area nodes). The nodes then report their identifiers and locations to the controller. A time stamp may also be reported. The controller 120 can then access the database 136 to determine if the node is a player node or a ball node, and, if the node is a player node, the name of the player. The relative locations of the ball and players are used to determine which player has possession of the ball. The location of the ball is used to determine scoring events or when the ball is out of play. The controller may also determine play sequences. This information is translated into a text message by the translator 124 and passed to the subscriber manager 126 for dissemination to subscribers 130. In addition, the processed data (player location and ball possession, for example) may be stored in the database 126 for later retrieval by the controller of by other devices (such as other court servers) networked to the database 136. The nodes may use a standard protocol, such as WiFi or ZigBee, or a custom protocol.

In general, both RFID tags and readers are considered to be special cases of wireless sensor nodes.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for automated play tracking in a sport played by a plurality of players comprising:
for each player of the plurality of players:
receiving a first message from a player wireless sensor node carried by the player;
receiving a second message from a ball wireless sensor node carried by a ball;
determining, from the first and second messages, the locations of the plurality of players and the ball;
determining, from the locations of the plurality of players and the ball, which, if any, of the plurality of players possess the ball; and
generating a third message that identifies which player, if any, of the plurality of players possess the ball.

2. A method in accordance with claim 1, further comprising storing the third message in a database.

3. A method in accordance with claim 1, further comprising transmitting the third message over a network to a subscriber device.

4. A method in accordance with claim 3, wherein the sport is played in a defined area of play, the method further comprising transmitting locations of the defined area of play over a network to the subscriber device.

5. A method in accordance with claim 1, further comprising generating a graphical visualization of play dependent upon the third message.

6. A method in accordance with claim 5, further comprising assigning avatars for players in the graphical visualization of play.

7. A method in accordance with claim 1, wherein the first message comprises an identifier of the player carrying the wireless sensor node, the location of the player in an area of play and a time stamp, the location of the player being determined by the player wireless sensor node.

8. A method in accordance with claim 7, wherein the location of the player is determined relative to nodes at fixed positions.

9. A method in accordance with claim 1, wherein the second message comprises the location of the ball and a time stamp, the location of the ball in an area of play, being determined by the ball wireless sensor node.

10. A method in accordance with claim 9, wherein the location of the ball is determined relative to nodes at one or more fixed scoring positions.

11. A method in accordance with claim 1, wherein the player wireless sensor nodes and the ball wireless sensor node use at least one communication protocol selected from a ZigBee communication protocol and WiFi protocol.

12. A method in accordance with claim 1, further comprising determining an order of play from successive locations of the plurality of players and the ball.

13. A method in accordance with claim 1, wherein the third message comprises a text message generated automatically dependent upon the locations of the plurality of players and the ball.

14. A method in accordance with claim 1, further comprising retrieving historical information from a database, wherein the third message includes historical information related to the play.

15. A system for automated play tracking in a sport played by a plurality of players comprising:
a plurality of fixed nodes positioned in an area of play;
a plurality of first sensor nodes, each carried by a player of the plurality of players and operable to read identifier information from at least one fixed node in proximity to the player;
a second sensor node carried by a ball and operable to read identifier information from at least one fixed node in proximity to the ball; and
a controller operable to receive information dependent upon the identifier information from the plurality of first sensor nodes and the second sensor node and further operable to produce play information comprising the locations of the plurality of players and the ball.

16. A system in accordance with claim 15, wherein the play information further comprises which, if any, of the plurality of players possesses the ball.

17. A system in accordance with claim 15, wherein the play information further comprises the players' identities.

18. A system in accordance with claim 15, further comprising:
a translator operable to produce a message containing the play information; and
a subscriber manager, operable to disseminate the play information to subscribers via a network.

19. A system in accordance with claim 15, wherein a fixed node of the plurality of fixed nodes comprises an RFID tag.

20. A system in accordance with claim 19, wherein the plurality of first sensor nodes and the second sensor node comprise RFID tag readers.

21. A system in accordance with claim 15, wherein a fixed node of the plurality of fixed nodes comprises a wireless sensor node.

22. A system in accordance with claim 15, wherein the plurality of first sensor nodes and the second sensor node comprise wireless sensor nodes.

23. A system in accordance with claim 15, wherein the controller comprises a receiver in the locality of the area of play and a processing device linked to the receiver via a data network 24. A method for receiving a play-by-play description of a sporting event played by a plurality of players using a ball, the method comprising:
downloading a description of an area of play from a subscriber manager;
downloading, from the subscriber manager, the locations and identifiers of a plurality of first sensor nodes, each first sensor node carried by a player of the plurality of players and in communication with the network server;
downloading the location of a second sensor node carried by the ball and in communication with the subscriber manager via a controller;
assigning an avatar to each identifier; and
generating a graphical visualization of the area of play showing avatars at the locations of the first sensor nodes and showing the location of the ball.

24. A method for automated play tracking in a sport played by a plurality of players comprising:
for each player of the plurality of players:
receiving a first message from a player wireless sensor node carried by the player;
receiving a second message from a ball wireless sensor node carried by a ball;
determining, from the first and second messages, the locations of the plurality of players and the ball;
determining, from the locations of the plurality of players and the ball, which, if any, of the plurality of players has achieved a score;
generating a third message that identifies which player, if any, of the plurality of players has achieved a score;
transmitting the third message to a subscriber device; and
the subscriber device inputting information derived from the third message to an application executed on the subscriber device.

25. A method in accordance with claim 24, wherein the application comprises a gaming application.
